(19) United States
(12) Patent Application Publication
(10) Pub. No.: US 2025/0046941 A1
(43) Pub. Date: Feb. 6, 2025

(54) BATTERY PACK WITH SUPPORT TABS

(71) Applicant: Apple Inc., Cupertino, CA (US)

(72) Inventors: Pengchuan Wang, San Jose, CA (US); Brian J. Haskins, Redwood City, CA (US); Claire E. Dalke, Foster City, CA (US); Matthew A. Mayer, Los Gatos, CA (US); Michael H. Tsai, San Jose, CA (US); Nathan J. Bohney, Campbell, CA (US); Sam Pan, San Mateo, CA (US)

(73) Assignee: Apple Inc., Cupertino, CA (US)

(21) Appl. No.: 18/229,507

(22) Filed: Aug. 2, 2023

(51) Int. Cl. H01M 50/291; H01M 50/204; H01M 50/244; H01M 50/502; H01M 50/516

(52) U.S. Cl. CPC H01M 50/291; H01M 50/204; H01M 50/244; H01M 50/502; H01M 50/516

(57) ABSTRACT

A battery pack that comprises a plurality of battery cells and a plurality of plates coupled between adjacent battery cells of the plurality of battery cells. The plates include a plate body and support ledges extending from the plate body. The battery pack further comprises a plurality of support tabs. Each support tab of the plurality of support tabs is positioned between, and abuts against, support ledges of adjacent plates of the plurality of plates. Each support tab of the plurality of support tabs secures adjacent plates of the plurality of plates to each other. The battery pack further comprises a busbar electrically coupling the plurality of battery cells together.

### CROSS-REFERENCES TO RELATED APPLICATIONS

This application is related to the following concurrently filed and commonly assigned U.S. nonprovisional patent application:
U.S. nonprovisional patent application Ser. No. ______, Filed ______, 2023, “BATTERY PACK WITH FLEXIBLE BUSBAR”, (Attorney Docket No. 090911-P61227US1-1375041),
   which is hereby incorporated by reference in its entirety for all purposes.

### BACKGROUND

As electronic devices develop in functionality, there is a commensurate demand on the battery cells which are used to power these electronic devices. At the same time, the size and weight constraints in electronic devices limit the number and size of the battery cells capable of being used in the electronic device. Accordingly, a need exists to maximize the energy provided by a battery pack while optimizing the shape and size of the battery pack.

### BRIEF SUMMARY

One aspect of the disclosure provides for a battery pack. The battery pack comprises a plurality of battery cells and a plurality of plates coupled between adjacent battery cells of the plurality of battery cells. The plates include a plate body and support ledges extending from the plate body. The battery pack further comprises a plurality of support tabs. Each support tab of the plurality of support tabs is positioned between, and abuts against, support ledges of adjacent plates of the plurality of plates. Each support tab of the plurality of support tabs secures adjacent plates of the plurality of plates to each other. The battery pack further comprises a busbar electrically coupling the plurality of battery cells together. A first plate of the plurality of plates may include a first ledge, a second plate of the plurality of plates may include a second ledge, and the first ledge and the second ledge may be offset from each other. A first support tab of the plurality of support tabs may define a first support area that receives the first ledge and a second support area that receives the second ledge. The first support tab may include a support tab body, and a first support tab extension and a second support tab extension extending from opposite ends of the support tab body. The first support tab extension and the support tab body may define the first support area and the second support tab extension and the support tab body defines the second support area. The first support tab extension may be offset from the second support tab extension. The first support area may be offset from the second support area. The first and second support tab extensions may be coupled to the plates. The first and second support tab extensions may be welded to the plates. A first plate of the plurality of plates defines a first sidewall and a second sidewall, a first battery cell of the plurality of battery cells positioned between the first sidewall and second sidewall, and a first space is defined between the first battery cell and the second sidewall and a second space is defined between the second battery cell and the second sidewall. A first battery cell of the plurality of battery cells may be positioned between a first plate and a second plate of the plurality of plates, the first battery cell may be coupled to the first plate, and the first battery cell and the second plate may define a space therebetween.

Another aspect of the disclosure provides for a battery pack. The battery pack comprises a plurality of plates. Each plate of the plurality of plates includes a plate body and mounting ledge extending from the plate body, and the mounting ledges are configured for securing the battery back to a housing. The battery pack may further comprise a plurality of battery cells. Each plate of the plurality of plates is coupled between adjacent battery cells of the plurality of battery cells and each battery cell of the plurality of battery cells is secured to one of the plate bodies of the plurality of plates. The battery pack may further comprise a busbar electrically coupling the plurality of battery cells together. Each plate of the plurality of plates may include a support ledge extending from the plate body and the support ledges and the mounting ledges may be transverse and coplanar with each other. The battery pack may further comprise a plurality of support tabs. Each support tab of the plurality of support tabs may be positioned between adjacent support ledges. Each support tab may include a support tab body, and a first support tab extension and a second support tab extension extending from opposite ends of the support tab body, and the first support tab extension and the support tab body may define a first support area that receives a first support ledge of the support ledges and the second support tab extension and the support tab body may define a second support area that receives a second support ledge of the support ledges. The first and second support ledges may be offset from each other, the first and second support tab extensions may be offset from each other, and the first and second support areas may be offset from each other.

Another aspect of the disclosure provides for a battery pack. The battery pack comprises a plurality of plates. Each plate of the plurality of plates includes a plate body and mounting ledge extending from the plate body, and the mounting ledges are configured for securing the battery back to a housing. The battery pack may further comprise a plurality of battery cells. Each plate of the plurality of plates is coupled between adjacent battery cells of the plurality of battery cells and each battery cell of the plurality of battery cells is secured to one of the plate bodies of the plurality of plates. The battery pack may further comprise a busbar electrically coupling the plurality of battery cells together. Each plate of the plurality of plates may include a support ledge extending from the plate body and the support ledges and the mounting ledges may be transverse and coplanar with each other. The battery pack may further comprise a plurality of support tabs. Each support tab of the plurality of support tabs may be positioned between adjacent support ledges. Each support tab may include a support tab body, and a first support tab extension and a second support tab extension extending from opposite ends of the support tab body, and the first support tab extension and the support tab body may define a first support area that receives a first support ledge of the support ledges and the second support tab extension and the support tab body may define a second support area that receives a second support ledge of the support ledges. The first and second support ledges may be offset from each other, the first and second support tab extensions may be offset from each other, and the first and second support areas may be offset from each other.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A depicts a top, isometric view of a battery pack according to embodiments of the disclosure.

FIG. 1B depicts a bottom, isometric view of the battery pack of FIG. 1A.

FIG. 1C depicts an exploded view of the battery pack of FIG. 1A

FIG. 2A depicts a top, isometric view of a battery pack according to embodiments of the disclosure.

FIG. 2B depicts a bottom, isometric view of the battery pack of FIG. 2A.

FIGS. 3A-3D depicts a top, isometric view of a method of forming a battery pack according to embodiments of the disclosure.

FIG. 4A depicts a top, isometric view of a busbar and battery management unit according to embodiments of the disclosure.

FIG. 4B depicts a bottom, isometric view of the busbar and battery management unit of FIG. 4A.

### DETAILED DESCRIPTION

Increasing the power output of a battery pack may involve certain challenges. For example, the battery cells (e.g., lithium-ion battery cells) housed in battery packs can achieve a certain maximum voltage with minimal risk of overcharging the battery cell. Once that voltage level is reached, further charging those battery cells may increase the risk of overcharging and damaging the battery cell. Accordingly, one way to increase the overall power output of a battery pack includes installing more battery cells within the battery pack. However, increasing the battery cell count within a battery pack may result in the geometry of the battery pack becoming less optimal for coupling with an electronic device (e.g., the battery pack having a wider surface area).

The present disclosure addresses this issue by providing for a battery pack structure that electrically couples multiple battery cells together in a vertical, stacked orientation by coupling with a plate assembly. This stacked orientation may be more conducive to being coupled to an electronic device than other non-stacked orientations, such as where the battery cells are positioned side-by-side. These non-stacked orientations may result in the battery packs having a larger surface area. The plate assembly may additionally provide improved structural rigidity for the battery pack. Further, this plate assembly may increase the replaceability of the battery pack as the battery pack may be more easily coupled and decoupled from the electronic device by coupling and decoupling the plate assembly from the electronic device.

Several illustrative embodiments will now be described with respect to the accompanying drawings, which form a part hereof. The ensuing description provides embodiment(s) only and is not intended to limit the scope, applicability, or configuration of the disclosure. Rather, the ensuing description of the embodiment(s) will provide those skilled in the art with an enabling description for implementing one or more embodiments. It is understood that various changes may be made in the function and arrangement of elements without departing from the spirit and scope of this disclosure. In the following description, for the purposes of explanation, specific details are set forth in order to provide a thorough understanding of certain inventive embodiments. However, it will be apparent that various embodiments may be practiced without these specific details. The figures and description are not intended to be restrictive.

Although the remaining portions of the description will routinely reference lithium-ion battery cells, it will be readily understood by the skilled artisan that the technology is not so limited. The present designs may be employed with any number of battery or energy storage devices, including other rechargeable and primary, or non-rechargeable, cell types, as well as electrochemical capacitors also known as supercapacitors or ultracapacitors, electrolysers, fuel cells, and other electrochemical devices. Moreover, the present technology may be applicable to battery cells and energy storage devices used in any number of technologies that may include, without limitation, phones and mobile devices, handheld electronic devices, wearable devices, laptops and other computers, appliances, heavy machinery, transportation equipment, spacecraft electronics payloads, vehicles, as well as any other device that may use battery cells or benefit from the discussed designs. Accordingly, the disclosure and claims are not to be considered limited to any particular example discussed, but can be utilized broadly with any number of devices that may exhibit some or all of the electrical or chemical characteristics of the discussed examples.

### I. Exemplary Battery Pack

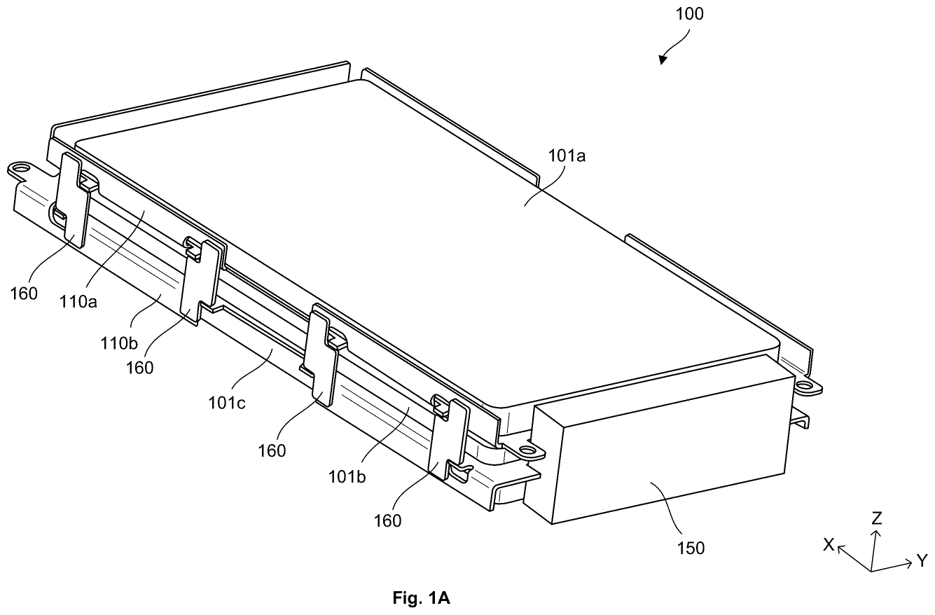

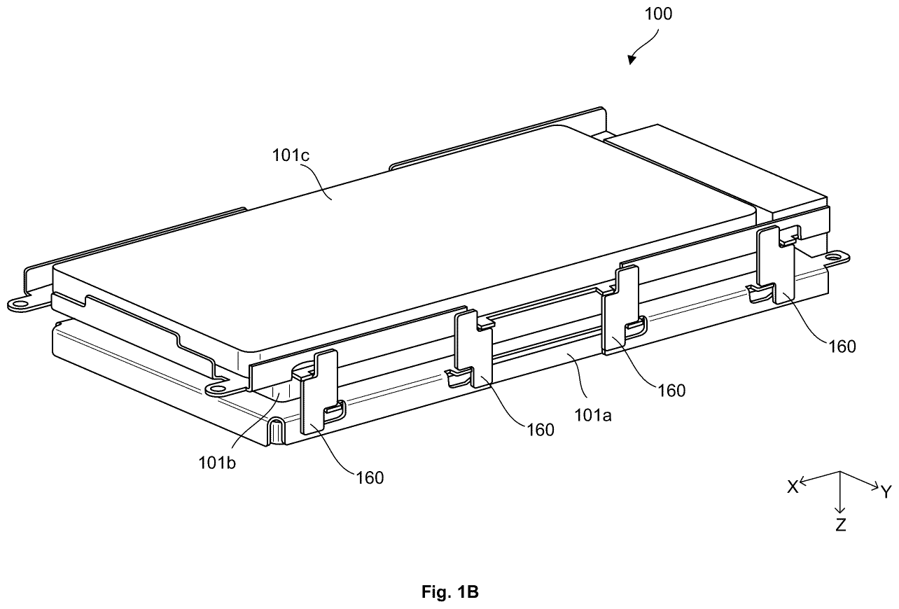

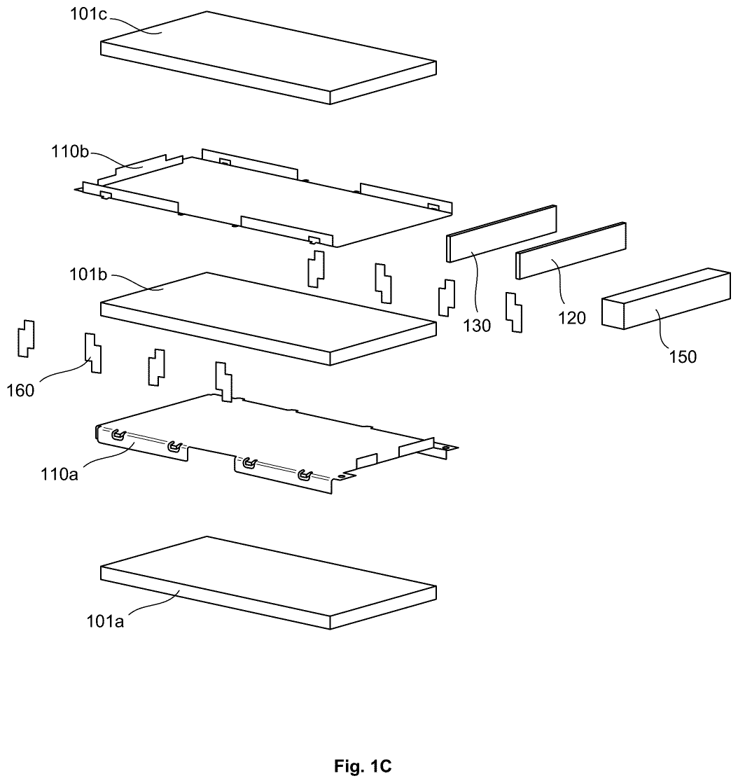

FIGS. 1A-1C depict an example battery pack 100. The battery pack 100 includes battery cells 101a-101c coupled to plates 110a, 110b. The battery cells 101a-101c may be or include a battery cell, and may be one of a number of cells coupled together to form a battery structure. The plates 110a, 110b, may be coupled to each other through support tabs 160. The plates 110a, 110b may be made from a metal, such as stainless steel, or other rigid materials. The plates 110a, 110b and the support tabs 160 may, collectively, define a plate assembly. The battery cells 101a-101c may be electrically coupled with a battery management unit (BMU) 120 through a busbar 130. The busbar 130 may include a metal (e.g., copper or aluminum) or a non-metal material, such as a polymer (e.g., a polyimide) or composite that may include a conductive material. As such, the busbar 130 may facilitate an electrical charge between the battery cells 101a-101c and the BMU 120. The busbar 130 may enable electrical connections between one or more of the battery cells 101a-101c and the BMU 120 in series or in parallel. The busbar 130 may be coupled (e.g., through one or more of a pressure-sensitive adhesive, welding, solder, or brazing) to the plate 110a and the BMU 120 may be coupled (e.g., through one or more of a pressure-sensitive adhesive, welding, solder, or brazing) to the busbar 130. The BMU 120 can be configured to control the operation of the battery cells 101a-101c. The busbar 130 may electrically couple the battery cells 101a, 101b to the BMU 120. The BMU 120 can also electrically couple the battery cells 101a-101c to other components that utilize power from the battery cells 101a-101c and to components that provide power to charge the battery cells 101a-101c (e.g., through one or more circuits). An enclosure 150 may be coupled to the plates 110a, 110b to provide protection to the busbar 130 and BMU 120.

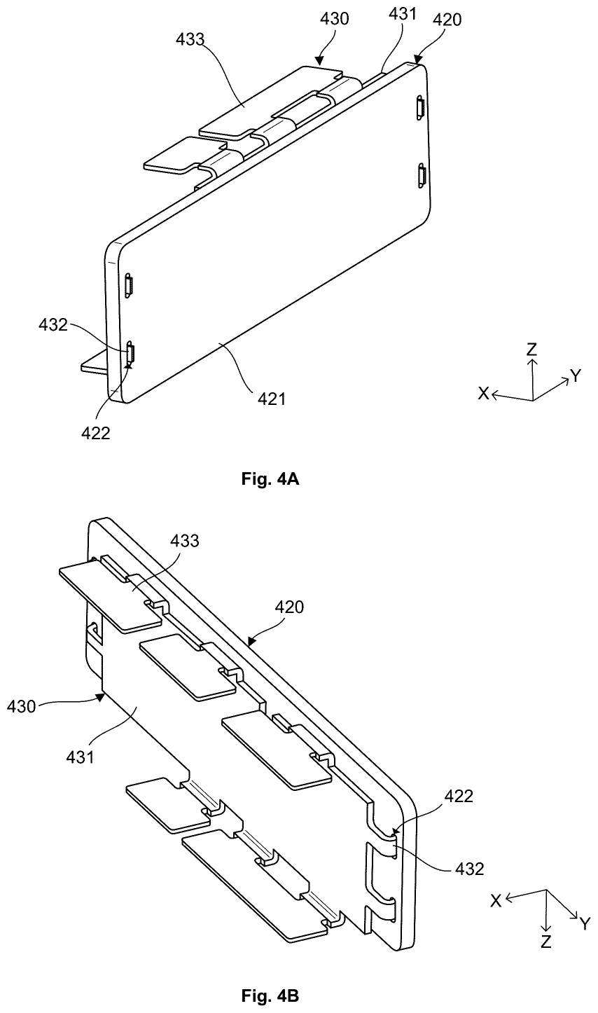

Turning to FIGS. 4A and 4B depict an example BMU 420 coupled to a busbar 430 for use with a battery pack, such as the battery pack 100. The busbar 430 may include a busbar body 431. The busbar body 431 may be substantially rectangular, however, in other embodiments, the busbar body may have any other shape. Unit coupling extensions 432 and battery coupling extensions 433 may extend from ends of the busbar body 431 along a Z-direction. The battery coupling extensions 433 may extend from the busbar body 431 in a direction opposite the unit coupling extensions 432. However, in other embodiments, the battery coupling extensions may extend in a similar direction as the unit coupling extensions.

The unit coupling extensions 432 may be shaped and sized to be received into the BMU 420 to couple the busbar 430 to the BMU 420. Specifically, the BMU 420 may include a BMU body 421 defining a plurality of receiving apertures 422 that are shaped and sized to receive the unit coupling extensions 432. For example, the unit coupling extensions 432 may be prong-shaped. The unit coupling extensions 432 may be soldered (e.g., point soldered) to the BMU body 421. In this manner, the BMU 420 may be mechanically coupled to the busbar 430. This mechanical coupling provides greater structural support to the BMU 420 when the busbar 430 is coupled to a plate of the battery pack (e.g., coupled to the plate 110a shown in FIGS. 1A and 1B using a pressure-sensitive adhesive or soldering) as now the BMU 420 may be mechanically coupled to the plate by being soldered to the busbar 430. The busbar 430 and the BMU 420 may be additionally coupled to each other through other coupling means, such as an adhesive (e.g., a pressure-sensitive adhesive) adhering the BMU body and the busbar body together. Further, the busbar 430 and the BMU 420 may be electronically coupled together through one or more electrical contact points along the busbar body 431 and the BMU body 421 such that the BMU 420 may control the power usage of the battery cells electrically coupled to the busbar 430. Although four unit coupling extensions 432 and four receiving apertures 422 are depicted, in other embodiments, there may be more or less than four unit coupling extensions and receiving apertures (e.g., three, five, six, or the like).

The battery coupling extensions 433 may be pads that are configured to electrically couple with one or more batteries (such as the batteries 101a-101c). There may be any number of battery coupling extensions 433 for electrically coupling with the battery cells. Further, the battery coupling extensions 433 may have any size or shape for electrically coupling with the battery cells. For example, at least some of the battery coupling extensions 433 may be configured to directly electrically couple with a battery (e.g., with the batteries 101a, 101c). Other battery coupling extensions 433 may be configured to indirectly electrically couple with one or more of the batteries (e.g., with the battery 101b) through an intermediate circuit. However, in other embodiments, the battery coupling extensions may all directly or indirectly electrically couple with all the battery cells.

As discussed above, increasing the number of battery cells within a battery pack can increase the power output of a battery pack. However, it may be difficult to electrically couple those battery cells together without limiting the shape and size of the battery pack to a particular configuration that is less able to be coupled to electronic devices. In particular, conventional configurations of battery packs may position the battery cells within a battery pack in a manner that may have a large surface area, thus providing for a battery pack that is less space efficient for coupling with electronic devices.

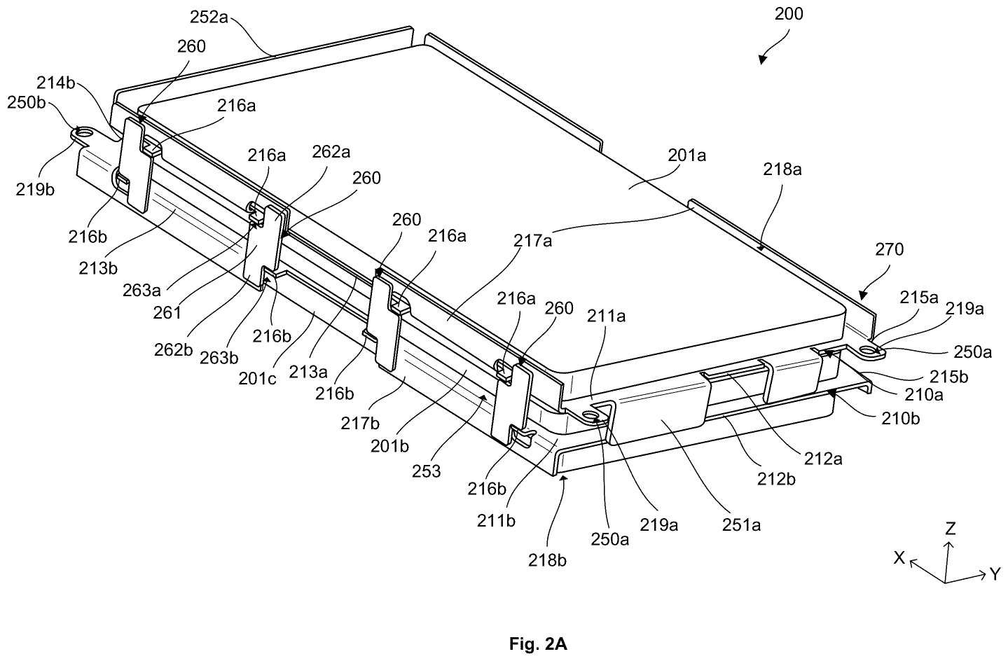

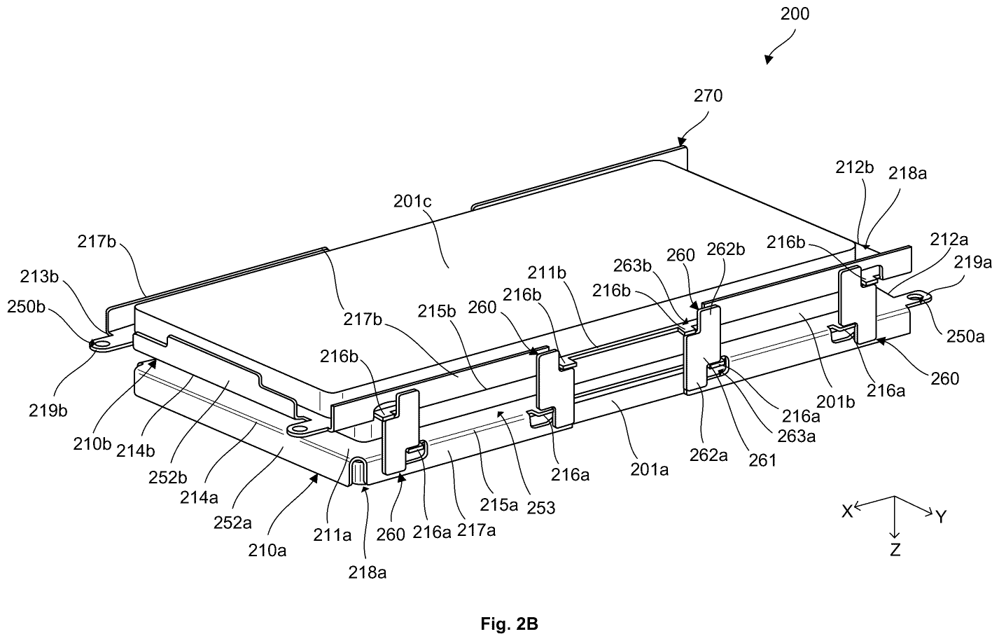

The plate assembly (i.e., the plates 110a, 110b coupled with the support tabs 160) can address this issue by providing a structural framework for the battery cells to couple with in a vertical direction (i.e., a Z-direction). For example, FIG. 2 depicts an example battery pack 200 with battery cells 201a-201c coupled to an example plate assembly 270. It is understood that features ending in like reference numerals as features discussed above are similar, except as noted below. The plate assembly 270 includes plates 210a, 210b coupled together through support tabs 260.

The plates 210a, 210b include plate bodies 211a, 211b having longitudinal edges 213a, 213b, 215a, 215b extending along an X-direction and lateral edges 212a, 212b, 214a, 214b extending along a Y-direction. The plate bodies 211a, 211b may be rectangular, however, in other embodiments, the plate bodies may have any other shape, such as circular, triangular, or the like. The plate bodies 211a, 211b may be planar along an X-Y plane. However, in other embodiments, the plate bodies may be non-planar, such as having a curved or angular shape. Further, the plate bodies 211a, 211b may be substantially parallel to each other. Substantially parallel means that the plate bodies 211a, 211b may have an angle of less than or about 30° relative to each other, such as less than or about 20°, such as less than or about 10°, or be completely parallel with each other. However, in other embodiments, the plate bodes may not be parallel to each other.

The plate bodies 211a, 211b may include a number of features extending from the edges 212a, 212b, 213a, 213b, 214a, 214b, 215a, 215b. For example, the plate bodies 211a, 211b may include longitudinal sidewalls 217a, 217b extending from the longitudinal edges 213a, 213b, 215a, 215b and lateral sidewalls 251a, 252a, 252b extending from the lateral edges 214a, 214b. The sidewalls 217a, 217b, 251a, 252a, 252b may extend from the longitudinal edges 213a, 213b, 215a, 215b in a Z-direction. For example, the longitudinal sidewalls 217a and the lateral sidewall 252a may extend upward along the Z-direction while the longitudinal sidewalls 217b, and lateral sidewalls 251a, 252b and may extend downward. However, in other embodiments, the longitudinal sidewalls can extend along any of the X-, Y-, or Z-axes. The lateral sidewalls 251a, 252a, 252b may extend from the lateral edges 214a, 214b a distance to provide sufficient surface area to couple with other components (e.g., the busbar 130, BMU 120) with the lateral sidewalls 251a, 252a, 252b, as discussed further below.

The sidewalls 217a, 217b, 251a, 252a, 252b may extend a distance along the Z-axis substantially similar to the battery cells 101a-101c. However, in other embodiments, the sidewalls may extend any height, such as a height less than the battery cells or more than the battery cells. Further, the sidewalls 217a, 217b, 251a, 252a may have a substantially rectangular shape while the lateral sidewall 252b may have an irregular shape (e.g., a shape having a discontinuous edge). However, in other embodiments, the sidewalls may all have a rectangular shape or may all have an irregular shape. In other embodiments, the plate may include sidewalls extending only from certain edges (e.g., only from the longitudinal edges or only from the lateral edges). In a yet further embodiment, there may be no sidewalls extending from the plate body. There may be multiple longitudinal sidewalls 217a 217b correspondingly extending from the longitudinal edges 213a, 213b, 215a, 215b while there may be a single lateral sidewall 252a, 252b correspondingly extending from the lateral edges 212a, 212b. However, in other embodiments, there may be any number of lateral and longitudinal sidewalls extending from the lateral and longitudinal edges.

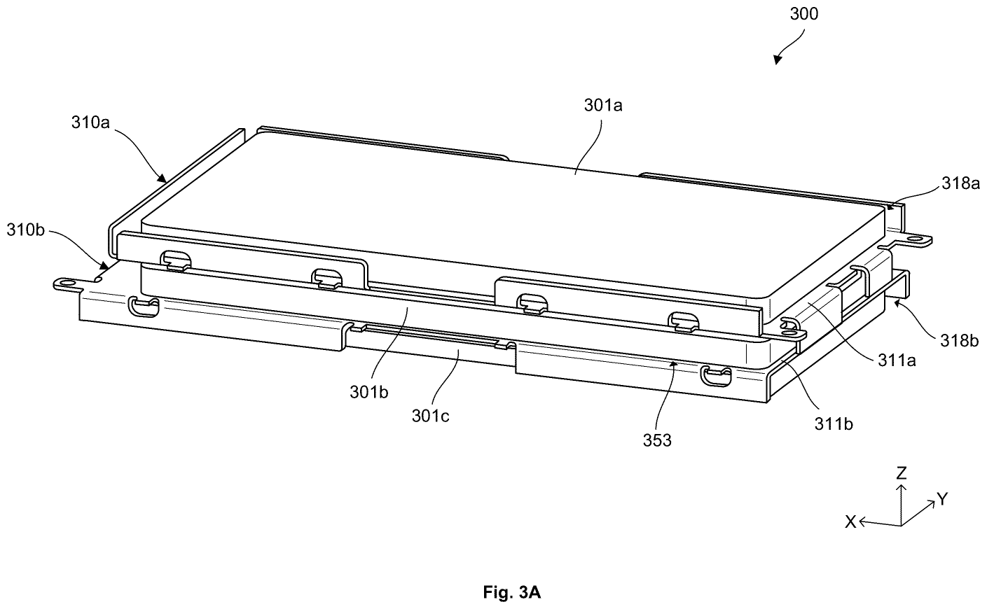

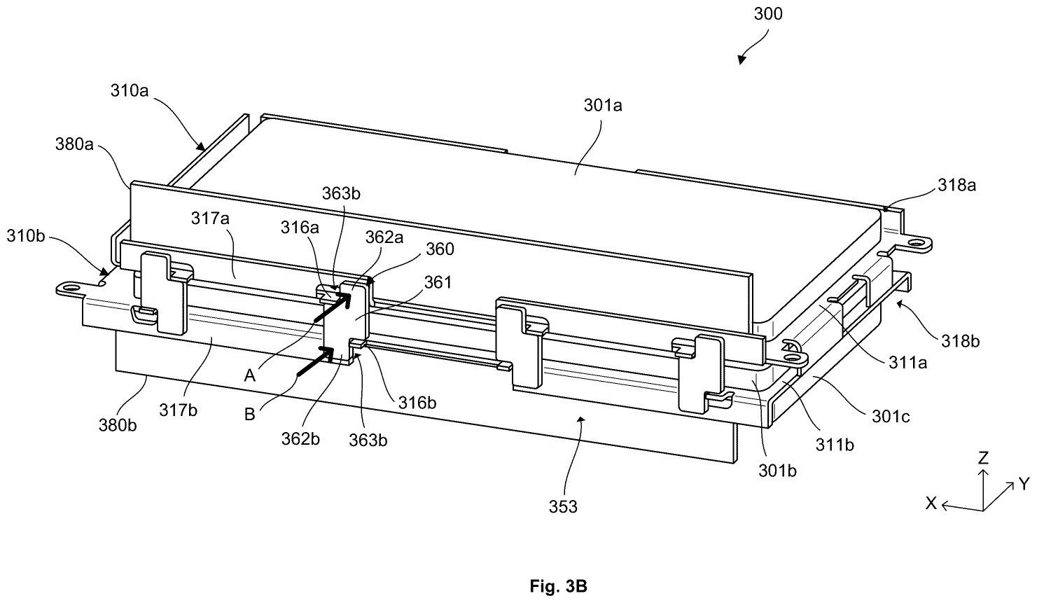

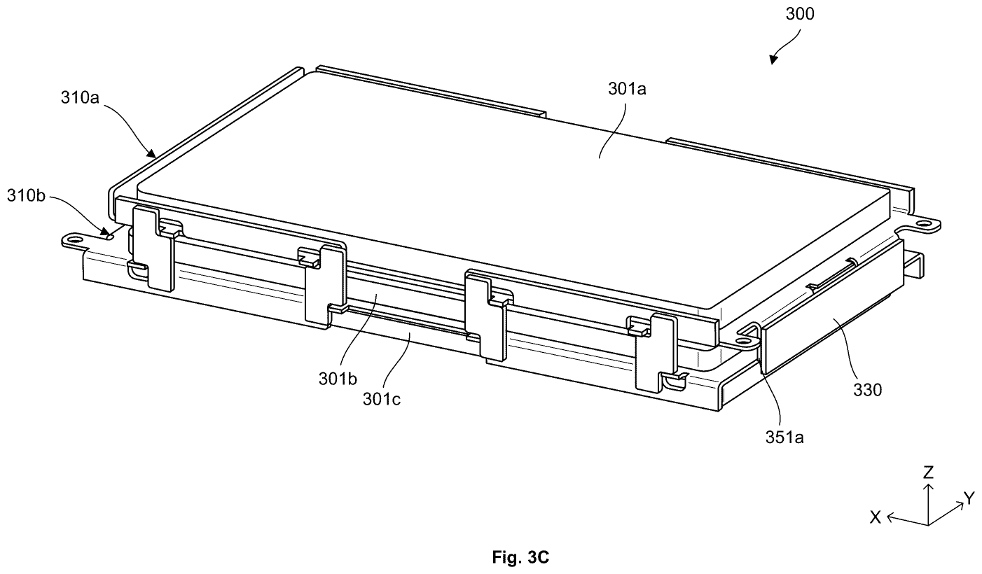

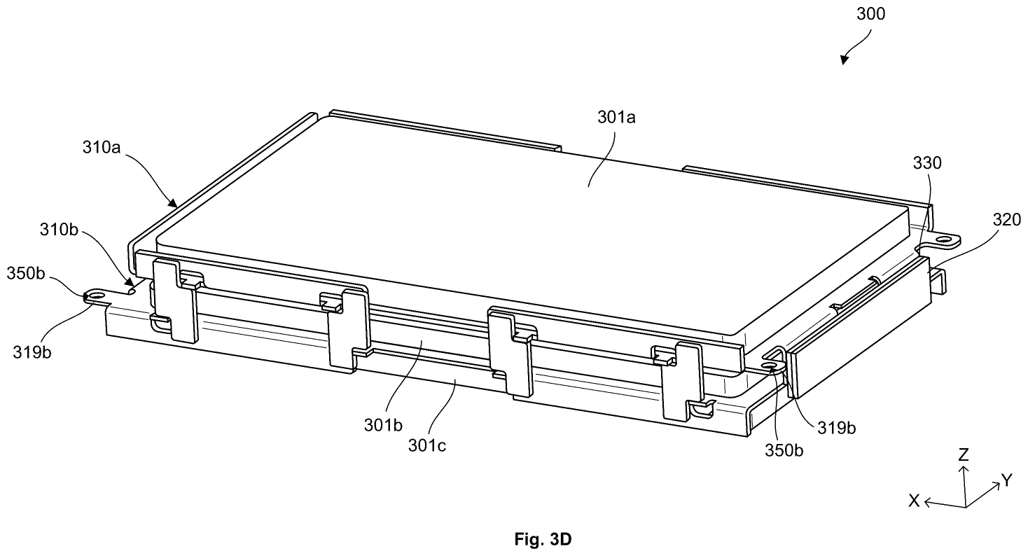

The longitudinal sidewalls 217a, 217b and the lateral sidewalls 252a, 252b may define plate cavities 218a, 218b therebetween. The plate cavities 218a, 218b may be defined to have a size and shape larger than the battery cells 101a, 101c. In this manner, the battery cells 101a, 101c may be received in the plate cavities 218a, 218b as well as other components. For example, the plate cavities 218a, 218b may be defined to have a size and shape for the battery cells 101a, 101c to be received in the plate cavities 218a, 218b along the plate bodies 211a, 211b while providing a space between the longitudinal sidewalls 217a, 217b and the battery cells 101a, 101c for other components (e.g., a shield 380a, 380b, as discussed in FIGS. 3A-3D further below) to be received between the longitudinal sidewalls 217a, 217b and the battery cells 201a, 201b. For example, this space may be between about 0.5 inches to 2 inches, such as between about 0.7 inches to 1.8 inches, between about 0.9 inches to 1.6 inches, or between about 1.1 inches to 1.4 inches. However, in other embodiments, the plate cavities may be defined to have a size and shape substantially similar to the size and shape of the battery cells such that there is no space defined between the sidewalls and the battery cells.

The plate bodies 211a, 211b, the lateral sidewalls 251a, and the support tabs 260 may define an internal cavity 253 therebetween. The internal cavity 253 may defined to have a shaped and size to receive at least the battery cell 201b. For example, the internal cavity 253 may include a distance between the plates 210a, 210b corresponding to the size of the support tabs 260, as discussed further below. The battery cell 201b may be received within the internal cavity 253 to couple with (e.g., via a pressure-sensitive adhesive) the plate body 211a. Further, the internal cavity 253 may have a height taller than the battery cell 201b such that, when the battery cell 201b is coupled with the plate body 211a, there is enough space between the battery cell 201b and the other plate body 211b to account for the battery cell 201b swelling when in use. However, in other embodiments, the battery cell received in the internal cavity may be coupled to the bottom plate or to both the adjacent plates.

The plate bodies 211a, 211b may include support ledges 216a, 216b extending from the longitudinal edges 213a, 213b along a Y-direction. The support ledges 216a, 216b may extend from the longitudinal edges 213a, 213b a distance along the Y-axis to overlay the support tabs 260 when the support tabs 260 are coupled with the plates 210a, 210b. Further, the support ledges 216a, 216b may include a width along the X-direction extending past the support tabs along the X-direction, however, in other embodiments, the support ledges may include a width that does not extend past the support tabs. The support ledges 216a, 216b may be rectangular, however, in other embodiments, the support ledges may have any other shape, such as circular, triangular, or the like. As will be discussed further below, the plates 210a, 210b may be supported by the support tabs 260 through the engagement between the support ledges 216a, 216b and the support tabs 260. Although four support ledges 216a, 216b are depicted extending from each of the longitudinal edges 213a, 213b, in other embodiments, there may be any number of support ledges extending from the longitudinal edges corresponding to the number of support tabs to be coupled to the longitudinal edges, such as more or less than four support ledges corresponding to more or less than four support tabs. In other embodiments, there may be other additional features extending from the support ledges, such as an additional sidewall extending along a Z-direction from an end of the support ledge farthest from the sidewalls.

The support ledges 216a may be vertically offset from the support ledges 216b a distance along an X-direction. The support ledges 216a may be vertically offset a distance based on the geometry of the support tabs 260, as discussed further below. However, in other embodiments, the support ledges may be aligned with each other.

The plate bodies 211a, 211b may include mounting ledges 219a, 219b extending from the lateral edges 212a, 214b along an X-direction. Specifically, the mounting ledges 219a may extend from the lateral edge 212a and the mounting ledges 219b may extend from the lateral edge 214b while the lateral edges 212b, 214a do not including mounting ledges extending therefrom. However, in other embodiments, the mounting ledges can extend from any of the edges, including one or more mounting ledges extending from each of the lateral and/or longitudinal edges. The mounting ledges 219a, 219b may extend from the plate bodies 211a, 211b at a transverse angle to the support ledges 216a, 216b (e.g., at an orthogonal angle). Further the mounting ledges 219a, 219b may be coplanar with the support ledges 216a, 216b. However, in other embodiments, the mounting ledges may not be coplanar with the support ledges and, instead, may be parallel and offset (e.g., along the Z-direction) with the support ledges. In a yet further embodiment, the mounting ledges may not be parallel with the support ledges.

The mounting ledges 219a, 219b may define apertures 250a, 250b for receipt of a fastener (e.g., a screw, bolt, nail, or the like). Further the mounting ledges 219a, 219b may extend from the longitudinal edges 213a, 213b a distance sufficient to couple with another component, such as an electronic device. In this manner, the battery pack 200 may be coupled to the electronic device through the mounting ledges 219a, 219b (e.g., by a fastener received through the apertures 250a, 250b). However, in other embodiments, the mounting ledges may not define any apertures and the mounting ledges may be coupled to the electronic device through welding, brazing, soldering, or the like.

The mounting ledges 219a, 219b may be rectangular, however, in other embodiments, the support ledges may have any other shape, such as circular, triangular, or the like. The mounting ledges 219a, 219b may extend from the lateral ends of lateral edges 212a, 214b (e.g., adjacent the longitudinal edges 213a, 213b, 215a, 215b), however, in other embodiments, the mounting ledges may extend along any portion of the lateral edge, such as along an intermediate portion of the lateral edge. The lateral sidewalls 251a, 251b are positioned between the mounting ledges 219a, 219b so that the components coupled to those lateral sidewalls 251a, 251b (e.g., a busbar and BMU) are positioned between the mounting ledges 219a, 219b. This may increase the space efficiency of the battery pack 200 as the space defined between each set of mounting ledges 219a, 219b along the Y-direction may include the other components coupled to the lateral sidewalls 251a, 251b rather than be unused space.

Although two mounting ledges 219a, 219b are depicted as extending from the lateral edges 212a, 214b, in other embodiments, there may be any number of mounting ledges, such as one, three, four, or the like. In other embodiments, there may be other features extending from the mounting ledges, such as an additional sidewall extending from an end of the mounting ledge along a Z-direction. In yet other embodiments, the mounting and support ledges may extend from either of the lateral and/or longitudinal edges. For example, the support ledges may extend from the lateral edges while the mounting ledges may extend from the longitudinal edges. In another example, both the lateral and longitudinal edges may include the mounting and support ledges extending from each.

The support tabs 260 may include a support tab body 261 with support tab extensions 262a, 262b extending from the support tab body 261. The support tabs 260 may be made from a metal, such as stainless steel, or other rigid materials. The support tab body 261 may be rectangular, however, in other embodiments, the support tab body may have any other shape, such as circular, triangular, or the like. Further, the support tab extensions 262a, 262b may be rectangular, however, in other embodiments, the support tab extensions may have any other shape, such as circular, triangular, or the like. The support tab extensions 262a, 262b may extend from opposite ends of the support tab body 261 along the Z-axis. The support tab extensions 262a, 262b may extend a distance from the support tab body 261 to provide a sufficient space to allow for the support tabs 260 to couple to the longitudinal sidewalls 217a, 217b. For example, as will be discussed further below, the support tab extensions 262a, 262b may be welded to the longitudinal sidewalls 217a, 217b and, accordingly, the support tab extensions 262a, 262b may include a sufficient area for this welding.

The support tab body 261 and support tab extensions 262a, 262b may define a support area 263a, 263b therebetween. The support area 263a, 263b may be sized and shaped to receive a corresponding support ledge 216a, 216b. For example, the support area 263a, 263b may be a cutout defined by the support tabs 260. The support tab extensions 262a, 262b may be vertically offset from each other a distance along the X-direction and, accordingly, defines the support areas 263a, 263b to be vertically offset from each other along the X-direction. However, in other embodiments, the support tab extensions and support areas may be vertically aligned with each other (e.g., where the support ledges are vertically aligned with each other). In one example, the support tabs may include four support tab extensions extending from the support tab body such that the support tab defines an “H” shape. In this example, the support areas may define an inlet between the support tab extensions to receive the support ledge of the plates.

The support areas 263a may receive the support ledges 216a and the support areas 263b may receive the support ledges 216b. The support ledges 216a, 216b may be received in the support areas 263a, 263b to abut against the support tab body 261. In this manner, the support tabs 260 may provide increased structural rigidity between the plates 210a, 210b through the contact between the support tab body 261 and the support ledges 216a, 216b. Further, this contact fixes the height of the internal cavity 253 to correspond to the height along the Z-direction of the support tab body 261. In some embodiments, the support ledges 216a, 216b may additionally abut against the support tab extensions 262a, 262b, however, in other embodiments, the support ledges may be distanced from the support tab extensions along the X-direction.

The support tabs 260 may additionally provide improved structural rigidity through the support tab extensions 262a, 262b being coupled to the longitudinal sidewalls 217a, 217b. For example, the support tab extensions 262a, 262b may be adhered, welded, brazed, soldered, or coupled to the longitudinal sidewalls 217a, 217b through other securing means. Accordingly, the coupled engagement between the support tabs 260 and the plates 210a, 210b (i.e., the plate assembly 270) may provide structural rigidity to the battery pack 300.

Although only three battery cells 201a-201c are depicted being coupled to the battery pack 200, in other embodiments, there may be more battery cells. For example, more plates and support tabs may be coupled along the Z-direction. In this configuration, more battery cells may be coupled to the battery packs as more plates are provided in the battery pack.

### I. Exemplary Method of Forming a Battery Pack

An exemplary method of forming a battery pack 300 will be discussed with reference to FIGS. 3A-3D. Turning first to FIG. 3A, the battery cells 301a-301c may first be coupled to the plates 310a, 310b. For example, the battery cells 301a-301c may be coupled to the plates 310a, 310b using a pressure-sensitive adhesive. Accordingly, the battery cells 301a-301c may be pressed onto the plate bodies 311a, 311b. Specifically, the battery cell 301a may be received in the plate cavity 318a to be pressed against the plate body 311a along the Z-direction. The battery cell 301c may be received in the plate cavity 318b to also be pressed against the plate body 311b in the Z-direction. The battery cell 301b may be received in the internal cavity 353 and pressed against one or more of the plate bodies 311a, 311b along the Z-direction correspondingly opposite the battery cells 301a, 301c. However, in other embodiments, the middle battery cell (e.g., the battery cell 301b) may be pressed against only one of the plates.

Turning to FIG. 3B, shields 380a, 380b may be positioned between the longitudinal sidewalls 317a, 317b and the battery cells 301a, 301c. The shields 380a, 380b may be plates having a rectangular shape, however, in other embodiments, the plate bodies may have any other shape, such as circular, triangular, or the like. The shields 380a, 380b may be made from a metal, such as stainless steel, or other rigid materials. The shields 380a, 380b may be received in the plate cavities 318a, 318b between the longitudinal sidewalls 317a, 317b and the battery cells 301a, 301c. In some embodiments, the distance between the longitudinal sidewalls 317a, 317b and the battery cells 301a, 301c along the Y-direction may be substantially similar to the thickness of the shields 380a, 380b. Accordingly, there may be no gaps between the shields 380a, 380b and the longitudinal sidewalls 317a, 317b and the battery cells 301a, 301c. However, in other embodiments, the distance between the longitudinal sidewalls and the battery cells may be larger than a thickness of the shields. Therefore, in this example, when the shields are positioned between the longitudinal sidewalls and the battery cells, there may be space between the shields and the longitudinal sidewalls, and/or space between the shields and the battery cells. As will be discussed further below, the shields 380a, 380b may be provided to protect the battery cells 301a, 301c while the support tabs 360 are coupled to the plates 310a, 310b.

Once the shields 380a, 380b are received in the plate cavities 3318a, 318b as discussed above, the support tabs 360 may be positioned to support the plates 310a, 310b. Specifically, the support ledges 316a, 316b may be received in the support areas 363a, 363b to abut against the support tab bodies 361. In some embodiments, the support ledges 316a, 316b may be received in the support areas 363a, 363b such that the support ledges 316a, 316b also abut against the support tab extensions 362a, 362b. However, in other embodiments, the support ledges may be received in the support areas distanced from the support tab extensions.

After the support tab bodies 361 are positioned between the support tab ledges 316a, 316b, the support tabs 360 may be coupled to the plates 310a, 310b. For example, the support tab extensions 362a, 362b may be welded to the longitudinal sidewalls 317a, 317b. Specifically, a welding tool may weld, the support tab extensions 362a, 362b to the longitudinal sidewalls 317a, 317b in a Y-direction, as shown by arrows A, B. In some embodiments, the support tabs 360 may additionally or alternatively be adhered, soldered, brazed, or coupled through other securement means to the longitudinal sidewalls 317a, 317b. Once the support tabs 360 are coupled to the plates 310a, 310b, the shields 380a, 380b may be removed, however, in other embodiments, the shields may remain in place within the plate cavities for the rest of the method.

Welding the support tabs 360 to the plates 310a, 310b in a direction toward the battery cells 301a, 301c may risk damaging the battery cells 301a, 301c without sufficient protection between the welding point and the battery cells 301a, 301c. While the longitudinal sidewalls 317a, 317b may be sufficient to provide such protection, the shields 380a, 380b further decrease (or eliminate entirely) the risk of damaging the battery cells 301a, 301c during the welding process. However, in other embodiments, the shields may not be used during the coupling process. For example, no shields may be used if the support tabs are adhered to the longitudinal sidewalls or if the longitudinal sidewalls are determined to provide enough protection to the battery cells. In a yet further embodiment, the shields may have a shape and size only large enough to be positioned between the welding locations and the battery cells (i.e., the shields may be sized and shaped to correspond to a size and shape of the support tab extension).

It may be preferable to couple the battery cells 301a-301c to the plates 310a, 310b before coupling the support tabs 360 to the plates 310a, 310b. If the battery cells were coupled to the plates after the support tabs were coupled to the plates (i.e., forming the plate assembly), there would be an increased risk of damaging the plate bodies. Specifically, once the plate assembly is formed and an internal cavity is defined between the plates, the interior region of the plate bodies may lack sufficient support for the battery cells to couple to without the interior region of the plate bodies denting or damaging during the coupling process. This may be a particular issue where the battery cells are coupled to the plate bodies using a pressure-sensitive adhesive and the battery cells are pressed against the plate bodies. In contrast, coupling the battery cells 301a-301c to the plates 310a, 310b prior to coupling the support tabs 360 to the plates 310a, 310b allows the battery cells 301a-301c to be coupled to the plates 310a, 310b before the internal cavity 353 is defined and while the interior region of the plate bodies 311a, 311b are supported (e.g., along a planar surface), thus minimizing or eliminating risk of damage from the coupling process.

Turning to FIG. 3C, the busbar 330 may be coupled to the lateral sidewall 351a. The busbar 330 may be coupled with one or more of a pressure-sensitive adhesive, welding, solder, brazing, or the like. In this manner, the busbar 330 may be rigidly attached to the structure of the battery pack 300 through the lateral sidewall 351a. The busbar 330 may be electrically coupled to the battery cells 301a-301c (e.g., by electrically coupling with pads extending from the busbar 330, such as battery coupling extensions 433 of the busbar 430, as shown in FIGS. 4A and 4B) before or after the busbar 330 is coupled to the lateral sidewall 351a.

Turning to FIG. 3D, the BMU 320 may be coupled to the busbar 330. The BMU 320 may be coupled with one or more of a pressure-sensitive adhesive, welding, solder, brazing, or the like. In this manner, the BMU 320 may be rigidly attached to the structure of the battery pack 300 through the busbar 330. The BMU 320 may be electrically coupled to the busbar 330 and, through the busbar 330, may be electrically coupled to the battery cells 301a-301c. Once the BMU 320 is coupled to the busbar 330, an enclosure (e.g., the enclosure 150 shown in FIGS. 1A-1C) may be coupled to the plates 310a, 310b to provide protection to the BMU 320 and the busbar 330, similar to the battery pack 100 shown in FIGS. 1A and 1B.

Once the battery pack 300 is formed, the battery pack 300 may be coupled to an electronic device (not shown) and, specifically, the BMU 320 may be electrically coupled to the electronic device to provide power to the electronic device. In one example, the battery pack 300 may be coupled to the electronic device by a fastener being received in the electronic device and the apertures 350a, 350b of the mounting ledges 319a, 319b. Accordingly, the battery pack 300 may be easily coupled and de-coupled with the electronic device by inserting and removing a fastener through the mounting ledges 319a, 319b. This may increase the replaceability of the battery pack 300 within the electronic device, such as where one or more of the battery cells 301a-301c become damaged or fail. In other embodiments, other types of coupling means between the battery pack and electronic device are envisioned, such as welding, brazing, soldering, adhesive, or the like.

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Additionally, spatially relative terms, such as “bottom or “top” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

In some implementations, operations or processing may involve physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining,” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

What is claimed is:

1. A battery pack, comprising:
a plurality of battery cells;
a plurality of plates coupled between adjacent battery cells of the plurality of battery cells, wherein the plates include a plate body and support ledges extending from the plate body; and
a plurality of support tabs, wherein:
each support tab of the plurality of support tabs is positioned between, and abuts against, support ledges of adjacent plates of the plurality of plates; and
each support tab of the plurality of support tabs secures adjacent plates of the plurality of plates to each other; and
a busbar electrically coupling the plurality of battery cells together.

2. The battery pack of claim 1, wherein:
a first plate of the plurality of plates includes a first ledge;
a second plate of the plurality of plates includes a second ledge; and
the first ledge and the second ledge are offset from each other.

3. The battery pack of claim 2, wherein a first support tab of the plurality of support tabs defines a first support area that receives the first ledge and a second support area that receives the second ledge.

4. The battery pack of claim 3, wherein:
the first support tab includes a support tab body, and a first support tab extension and a second support tab extension extending from opposite ends of the support tab body; and
the first support tab extension and the support tab body defines the first support area and the second support tab extension and the support tab body defines the second support area.

5. The battery pack of claim 4, wherein:
the first support tab extension is offset from the second support tab extension; and
the first support area is offset from the second support area.

6. The battery pack of claim 4, wherein the first and second support tab extensions are coupled to the plates.

7. The battery pack of claim 6, wherein the first and second support tab extensions are welded to the plates.

8. The battery pack of claim 1, wherein:
a first plate of the plurality of plates defines a first sidewall and a second sidewall;
a first battery cell of the plurality of battery cells positioned between the first sidewall and second sidewall; and
a first space is defined between the first battery cell and the second sidewall and a second space is defined between the second battery cell and the second sidewall.

9. The battery pack of claim 1, wherein:
a first battery cell of the plurality of battery cells is positioned between a first plate and a second plate of the plurality of plates;
the first battery cell is coupled to the first plate; and
the first battery cell and the second plate define a space therebetween.

10. A battery pack, comprising:
a plurality of plates, wherein:
each plate of the plurality of plates includes a plate body and mounting ledge extending from the plate body;
the mounting ledges are configured for securing the battery back to a housing;
a plurality of battery cells, wherein:
each plate of the plurality of plates is coupled between adjacent battery cells of the plurality of battery cells; and
each battery cell of the plurality of battery cells is secured to one of the plate bodies of the plurality of plates; and
a busbar electrically coupling the plurality of battery cells together.

11. The battery pack of claim 10, wherein;
each plate of the plurality of plates includes a support ledge extending from the plate body; and
the support ledges and the mounting ledges are transverse and coplanar with each other.

12. The battery pack of claim 11,
further comprising a plurality of support tabs; and
wherein each support tab of the plurality of support tabs positioned between adjacent support ledges.

13. The battery pack of claim 12, wherein:
each support tab includes a support tab body, and a first support tab extension and a second support tab extension extending from opposite ends of the support tab body; and
the first support tab extension and the support tab body defines a first support area that receives a first support ledge of the support ledges and the second support tab extension and the support tab body defines a second support area that receives a second support ledge of the support ledges.

14. The battery pack of claim 13, wherein:
the first and second support ledges are offset from each other;
the first and second support tab extensions are offset from each other; and
the first and second support areas are offset from each other.

15. A method of forming a battery pack, comprising:
coupling a plurality of plates between a plurality of battery cells, the plates including a plate body and support ledges extending laterally from the plate body;
after coupling the plurality of plates between the plurality of battery cells, welding a support tab to adjacent plates of the plurality of plates in a welding direction toward the plurality of battery cells; and
electrically coupling the plurality of battery cells together with a busbar.

16. The method of claim 15,
wherein:
the support tab includes a support tab body, and a first support tab extension and a second support tab extension extending from opposite ends of the support tab body; and
the first support tab extension and the support tab body defines a first support area and the second support tab extension and the support tab body defines a second support area; and
the method further comprises positioning the support tab body between the support ledges such that a first support ledge of a first plate of the plurality of plates is positioned within the first support area and a second support ledge of a second plate of the plurality of plates is positioned within the second support area.

17. The method of claim 16, wherein:
the first and second support ledges are offset from each other;
the first and second support tab extensions are offset from each other; and
the first and second support areas are offset from each other.

18. The method of claim 15,
wherein:
a first plate of the plurality of plates includes a first sidewall and a second sidewall; and
coupling the plurality of plates between the plurality of battery cells includes positioning a first battery cell of the plurality of battery cells between the first and second sidewalls; and
before welding the support tab to the adjacent plates, the method further comprises positioning a shield between the first sidewall and the first battery cell to intersect an axis defined by the welding direction.

19. The method of claim 18, wherein welding the support tab to the adjacent plates includes welding the support tab to the first sidewall along the welding direction.

20. The method of claim 18, further comprising, after welding the support tab to the adjacent plates, removing the shield from between the first sidewall and the first battery cell.
